(19) United States
(12) Patent Application Publication
(10) Pub. No.: US 2023/0218003 A1
(43) Pub. Date: Jul. 13, 2023

(54) HEATING ELEMENT, VAPORIZATION COMPONENT, AND ELECTRONIC VAPORIZATION DEVICE

(71) Applicant: SHENZHEN SMOORE TECHNOLOGY LIMITED, Shenzhen (CN)

(72) Inventors: Ming LV, Shenzhen (CN); Yinxiang DUAN, Shenzhen (CN); Mingda ZHU, Shenzhen (CN); Yuming XIONG, Shenzhen (CN)

(21) Appl. No.: 18/184,853

(22) Filed: Mar. 16, 2023

Related U.S. Application Data
(63) Continuation of application No. PCT/CN2021/104598, filed on Jul. 5, 2021.

(51) Int. Cl. A24F 40/46; H05B 3/26; A24F 40/10; A24F 40/485

(52) U.S. Cl. CPC A24F 40/46; H05B 3/265; A24F 40/10; A24F 40/485; H05B 2203/021

(57) ABSTRACT

A heating element including a dense substrate and a heating film is disclosed. The dense substrate includes a first surface and a second surface opposite to the first surface. A plurality of micro-pores are arranged in the dense substrate. The micro-pores are through holes, and each of the micro-pores is configured to guide an aerosol-forming medium to the first surface. The heating film is formed on the first surface. A ratio of a thickness of the dense substrate to a pore size of the micro-pore is in a range of 20:1-3:1.

### CROSS-REFERENCE TO RELATED APPLICATION

This application is a continuation of International Application No. PCT/CN2021/104598, filed on Jul. 5, 2021, the entire disclosure of which is hereby incorporated by reference.

### TECHNICAL FIELD

The present disclosure relates to the technical field of vaporizers, and in particular, to a heating element, a vaporization component, and an electronic vaporization device.

### BACKGROUND

A typical electronic vaporization device consists of a heating element, a battery, and a control circuit. The heating element is used as the core element of the electronic vaporization device, and its characteristics determine the vaporization effect and user experience of the electronic vaporization device.

Existing heating elements mainly include a cotton core heating element and a ceramic heating element. The cotton core heating element is mostly a structure formed by winding a cotton rope or a fiber rope around a spring-shaped metal heating wire. A to-be-vaporized liquid aerosol-forming medium is absorbed by two ends of the cotton rope, and then transferred to a central metal heating wire to be heated and vaporized. Ceramic heating elements mostly operate in such a way to form a heating film on a surface of a porous ceramic body which functions to guide and store a liquid.

With the advancement of technology, users have increasingly high requirements for the vaporization effect of the electronic vaporization device. In order to satisfy the requirements of users, it is necessary to provide a heating element with a better vaporization effect.

### SUMMARY

In view of this, the present invention provides a heating element, a vaporization component, and an electronic vaporization device, so as to resolve the technical problem of how to satisfy requirements of a user for the vaporization effect in the prior art.

In order to solve the above technical problem, a first technical solution provided in this disclosure is to provide a heating element, including a dense substrate and a heating film. The dense substrate includes a first surface and a second surface opposite to the first surface. Micro-pores are arranged in the dense substrate, the micro-pores are through holes, and each of the micro-pores is configured to guide an aerosol-forming medium to the first surface. The heating film is formed on the first surface. A resistance of the heating film at a room temperature is in a range of 0.5 Ohms to 2 Ohms, a thickness of the heating film is in a range of 200 nanometers to 5 micrometers, and a material of the heating film includes aluminum and its alloy as well as gold and its alloy.

The plurality of micro-pores are arranged in an array.

Shapes and pore sizes of the plurality of micro-pores are the same, and the plurality of micro-pores are arranged in a rectangular array.

The heating element includes a first-pore-size micro-pore array region and a second-pore-size micro-pore array region, and the pore size of the micro-pore in the second-pore-size micro-pore array region is different from the pore size of the micro-pore in the first-pore-size micro-pore array region.

The first surface and the second surface both include smooth surfaces. The first surface is a plane, the micro-pore is a straight-through hole perpendicularly extending through the first surface and the second surface, and a cross-section of the micro-pore is circular.

The first surface and the second surface are both planes and are arranged in parallel. The dense substrate is glass or dense ceramic.

The dense substrate is glass, and the glass is borosilicate glass, quartz glass, or photosensitive lithium aluminosilicate glass. A ratio of a thickness of the dense substrate to the pore size of the micro-pore is in a range of 15:1-5:1.

A ratio of a distance between centers of two adjacent micro-pores to the pore size of the micro-pore is in a range of 3:1-1.5:1.

A ratio of a distance between centers of two adjacent micro-pores to the pore size of the micro-pore is in a range of 3:1-2.5:1. The thickness of the dense substrate is in a range of 0.1 millimeters to 1 millimeter.

The thickness of the dense substrate is in a range of 0.2 millimeters to 0.5 millimeters. The pore size of the micro-pore is in a range of 1 micrometer to 100 micrometers.

The pore size of the micro-pore is in a range of 20 micrometers to 50 micrometers. A longitudinal section of the through hole is in a rectangle shape or a dumbbell shape. The micro-pore extends through the heating film.

A material of the heating film is silver, copper, aluminum, gold, or an alloy thereof, a thickness of the heating film is in a range of 200 nanometers to 5 micrometers, a resistance of the heating film is in a range of 0.5 Ohms to 2 Ohms, and a resistivity of the heating film is not greater than 0.06×10⁻⁶ Ohm-meters (Ωm).

A material of the heating film is one of a nickel-chromium alloy, a nickel-chromium-iron alloy, an iron-chromium-aluminum alloy, nickel, platinum, or titanium, and a thickness of the heating film is in a range of 5 micrometers to 100 micrometers.

The heating film is in a shape of a sheet, a grid, and a strip.

The heating element further includes a protective film. The protective film is arranged on a surface of the heating film away from the dense substrate, and a material of the protective film is one of stainless steel, a nickel-chromium-iron alloy, or a nickel-based corrosion-resistant alloy.

In order to resolve the above technical problem, a second technical solution provided in this disclosure is to provide a vaporization component, including a liquid storage cavity and a heating element.

The liquid storage cavity is configured to store a liquid aerosol-forming medium. The heating element is the heating element in any of the above, and the micro-pore is in communication with the liquid storage cavity.

The vaporization component further includes a loose substrate. The loose substrate is arranged on the second surface of the dense substrate of the heating element. The loose substrate is selected from porous ceramic, a sponge, foam, or a fiber layer.

In order to solve the above technical problem, a second technical solution provided in this disclosure is to provide an electronic vaporization device, including a vaporization component and a power supply component. The vaporization component is the vaporization component in any of the above, and the power supply component is electrically connected to the heating element.

The power supply component includes a battery, a voltage of the battery is in a range of 2.5 volts to 4.4 volts, and a power of the electronic vaporization device is in a range of 6 watts to 8.5 watts.

The beneficial effects of the present disclosure are as follows: Different from the related art, the heating element in this disclosure includes a dense substrate and a heating film. The dense substrate includes a first surface and a second surface opposite to the first surface. A plurality of micro-pores are arranged in the dense substrate, the micro-pores are through holes, and each of the micro-pore is configured to guide an aerosol-forming medium to the first surface. The heating film is formed on the first surface. A ratio of a thickness of the dense substrate to the pore size of the micro-pore is in a range of 20:1-3:1. Through the above arrangement, the magnitude of the porosity of the heating element can be precisely controlled, thereby improving the consistency of products, and the sufficient liquid supply and the prevention of liquid leakage are both realized during the operation of the heating element.

### BRIEF DESCRIPTION OF THE DRAWINGS

To describe the technical solutions in the embodiments of this disclosure more clearly, the following briefly introduces the accompanying drawings required for describing the embodiments. Apparently, the accompanying drawings in the following description show only some embodiments of this disclosure, and a person of ordinary skill in the art may still derive other accompanying drawings from these accompanying drawings without creative efforts.

FIG. 1 is a schematic structural diagram of an electronic vaporization device according to this disclosure.

FIG. 2 is a schematic structural diagram of a vaporization component according to this disclosure.

FIG. 3 is a schematic structural diagram of a heating element according to this disclosure.

FIG. 4 is a schematic structural diagram of a dense substrate in the heating element provided in FIG. 3.

FIG. 5a is a schematic structural diagram of a first implementation of a micro-pore in the dense substrate provided in FIG. 3.

FIG. 5b is a schematic structural diagram of a second implementation of a micro-pore in the dense substrate provided in FIG. 3.

FIG. 5c is a schematic structural diagram of a third implementation of a micro-pore in the dense substrate provided in FIG. 3.

FIG. 5d is a schematic structural diagram of a fourth implementation of a micro-pore in the dense substrate provided in FIG. 3.

FIG. 6a is a schematic structural top view of a first implementation of the dense substrate provided in FIG. 3.

FIG. 6b is a schematic structural top view of a second implementation of the dense substrate provided in FIG. 3.

FIG. 7 is a schematic flowchart of a manufacturing process of the dense substrate provided in FIG. 6b.

FIG. 8a is a schematic structural top view of step S1 in FIG. 7.

FIG. 8b is a schematic structural side view of step S1 in FIG. 7.

FIG. 8c is a schematic structural top view of step S2 in FIG. 7.

FIG. 8d is a schematic structural side view of step S2 in FIG. 7.

FIG. 9a is a schematic structural top view showing that a heating film in a heating element according to this disclosure is a thick film.

FIG. 9b is a schematic structural top view of the heating element provided in FIG. 3.

FIG. 10 is a schematic structural diagram showing that a heating element according to this disclosure includes a protective film and the heating film is a thin film.

FIG. 11 is a schematic structural top view showing that a heating element according to this disclosure includes a protective film and the heating film is a thick film.

FIG. 12 is a partial schematic structural diagram of a vaporization component according to this disclosure including a loose substrate.

FIG. 13 is an SEM image of an implementation of a heating film according to this disclosure.

FIG. 14 is a comparison diagram of an amount of vaporized aerosol of the heating element of this disclosure and an amount of vaporized aerosol of the conventional porous ceramic heating element.

FIG. 15 is a failure diagram of the heating film in the heating element according to this disclosure.

FIG. 16 is an SEM image and an EDS image of the failure diagram of the heating film provided in FIG. 15.

FIG. 17 is a graph showing a relationship between lifetime of the heating film and a thickness of the protective film in the heating element according to this disclosure.

FIG. 18 is a schematic diagram of wet combustion performed on a heating element according to this disclosure.

FIG. 19 is a graph showing a relationship between a ratio of a thickness of the dense substrate of the heating element according to this disclosure to a pore size of a micro-pore and a vaporization amount.

FIG. 20 is a graph showing a relationship between a vaporization temperature and a heating power of the conventional porous ceramic heating element.

FIG. 21 is a graph showing a relationship between a vaporization temperature and a heating power of the heating element according to this disclosure.

FIG. 22 is a graph showing a relationship between a vaporization temperature and a puffing time of the heating element according to this disclosure.

### DETAILED DESCRIPTION

The technical solutions in the embodiments of this disclosure are clearly and completely described below with reference to the accompanying drawings in the embodiments of this disclosure. Apparently, the described embodiments are merely some rather than all of the embodiments of this disclosure. All other embodiments obtained by a person skilled in the art based on the embodiments of this disclosure without creative efforts shall fall within the protection scope of this disclosure.

In this disclosure, the terms “first”, “second” and “third” are used merely for the purpose of description, and shall not be construed as indicating or implying relative importance or implying a quantity of indicated technical features. Therefore, features defining “first” “second” and “third” can explicitly or implicitly include at least one of the features. In description of this disclosure, “more” means at least two, such as two and three unless it is specifically defined otherwise. All directional indications (for example, up, down, left, right, front, back) in the embodiments of this disclosure are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

“Embodiment” mentioned in the specification means that particular features, structures, or characteristics described with reference to the embodiment may be included in at least one embodiment of this disclosure. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

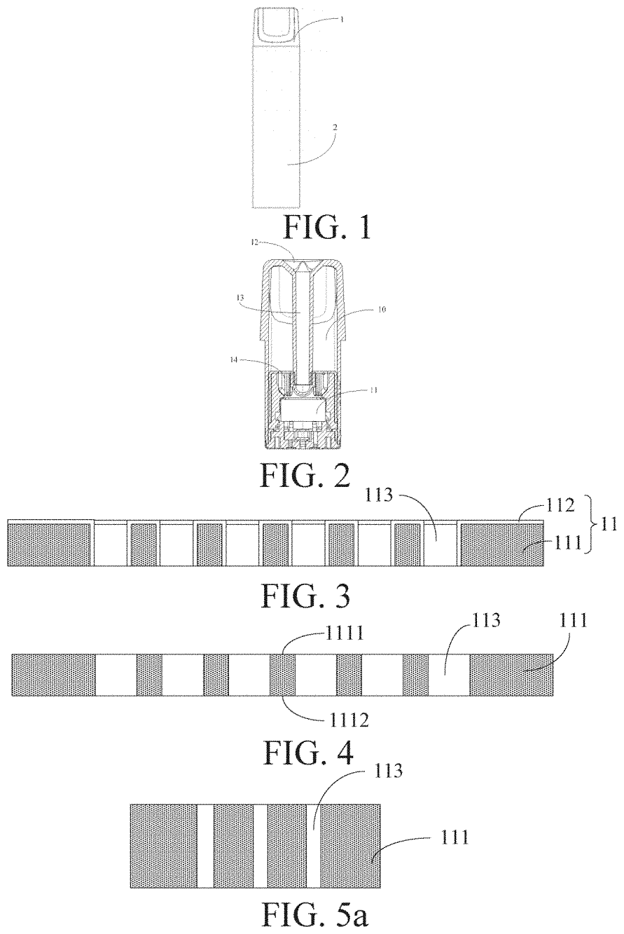

Referring to FIG. 1, FIG. 1 is a schematic structural diagram of an electronic vaporization device according to this disclosure.

The electronic vaporization device may be configured for vaporization of a liquid substrate. The electronic vaporization device includes a vaporization component 1 and a power supply component 2 that are connected to each other. The vaporization component 1 is configured to store a liquid aerosol-forming medium and vaporize the aerosol-forming medium to form an aerosol that can be inhaled by a user. The liquid aerosol-forming medium may be liquid substrates such as a medicinal liquid, a plant grass liquid, or the like. The vaporization component 1 may be specifically used in different fields such as medical treatment, electronic aerosolization, and the like. The power supply component 2 includes a battery (not shown), an airflow sensor (not shown), and a controller (not shown). The battery is configured to supply power to the vaporization component 1, so that the vaporization component 1 can vaporize a to-be-vaporized substrate to form aerosol. The airflow sensor is configured to detect an airflow change in the electronic vaporization device, and the controller starts the electronic vaporization device according to the airflow change detected by the airflow sensor. The vaporization component 1 and the power supply component 2 may be integrally arranged or detachably connected, which is designed according to specific requirements.

Referring to FIG. 2, FIG. 2 is a schematic structural diagram of a vaporization component according to this disclosure.

The vaporization component 1 includes a liquid storage cavity 10, a heating element 11, a suction nozzle 12, and a vapor outlet channel 13. The liquid storage cavity 10 is configured to store a liquid aerosol-forming medium, and the heating element 11 is configured to vaporize the aerosol-forming medium in the liquid storage cavity 10. In this implementation, a liquid flowing channel 14 is formed between the liquid storage cavity 10 and the heating element 11 to guide the liquid in the liquid storage cavity 10 to the heating element 11. In another implementation, the heating element 11 may also be directly exposed to the liquid storage cavity 10 to vaporize the liquid in the liquid storage cavity 10. The aerosol vaporized by the heating element 11 reaches the suction nozzle 12 through the vapor outlet channel 13, and is sucked by a user. The heating element 11 is electrically connected to the power supply component 2 to vaporize the aerosol-forming medium.

At present, the commonly used heating elements 11 include a cotton core heating element and a porous ceramic heating element. A structure of the cotton core heating element is mostly formed by winding a cotton rope or a fiber rope around a spring-shaped metal heating wire. The spring-shaped metal heating wire needs to play the role of structural support in the structure of the cotton core heating element. In order to achieve sufficient strength, a diameter of the metal heating wire is usually several hundreds of micrometers. A to-be-vaporized liquid aerosol-forming medium is absorbed by two ends of the cotton rope or the fiber rope, and then transferred to a central metal heating wire to be heated and vaporized. A structure of the porous ceramic heating element is formed by embedding a spring-shaped metal heating wire in a cylindrical porous ceramic body, and the porous ceramic body functions to guide and store a liquid. Another structure of the porous ceramic heating element is formed by printing thick-film metal paste on the porous ceramic body, and then metal wires are formed on the porous ceramic body after sintering at a high temperature. Since the pore size of the micro-pore varies from 1 micrometer to 100 micrometers, the porous ceramic surface is relatively rough. In order to form a continuous and stable metal film wire, a thickness of the metal film wire usually exceeds 100 micrometers.

The porous ceramic heating element is increasingly popular in the market due to relatively high temperature stability and relative safety. A common structure of the porous ceramic heating element is formed by printing a thick-film metal wire on the porous ceramic surface. A material of the thick-film metal wire of the existing electronic vaporization device is usually selected from a nickel-chromium alloy, a nickel-chromium-iron alloy, or an iron-chromium-aluminum alloy with a high resistivity. When the liquid aerosol-forming medium is repeatedly heated by the thick-film metal wire, excessive heavy metal ions such as nickel and chromium are often detected in the aerosol. The accumulation of heavy metal ions will damage human organs such as lungs, liver, kidneys, and the like, which will bring huge safety hazards to users.

In addition, for the above structure of the cotton core heating element and the porous ceramic heating element, during energization, the metal heating wire or the thick-film metal wire is heated, and the heat is transferred to the liquid in the cotton rope or the porous ceramic body, so that the liquid is heated and vaporized. Since the metal heating wire or thick-film metal wire is a dense entity, during energization, the metal heating wire or the thick-film metal wire needs to be first heated. Only the liquid near the metal heating wire or the thick-film metal wire is directly heated by the metal heating wire or the thick-film metal wire, and the liquid in the distance needs to be heated and vaporized by the heat transferred by the cotton rope or the porous ceramic body. Energy provided by the battery needs to heat the metal heating wire or the thick-film metal wire, and further needs to heat the entire liquid transmission medium. This heating method has the disadvantage of low vaporization efficiency.

The power of the existing electronic vaporization device does not exceed 10 watts, and the power is generally in a range of 6 watts to 8.5 watts, and a voltage range of the battery used by the existing electronic vaporization device is in a range of 2.5 volts to 4.4 volts. For a closed electronic vaporization device (an electronic vaporization device that does not require the user to inject a to-be-vaporized substrate), the voltage range of the battery used is in a range of 3 volts to 4.4 volts.

The inventor of this disclosure has found that since a liquid guide substrate made of dense materials such as glass has a smooth surface, physical vapor deposition or chemical vapor deposition may be adopted. A continuous and stable metal heating film is deposited on the surface of the liquid guide substrate, and a thickness of the metal heating film is in a range of several micrometers or nanometers. In this way, the heating element 11 can be miniaturized, and the material of the heating film can also be saved.

However, the inventor of this disclosure found that, compared with the existing cotton core heating element and the porous ceramic heating element, the liquid guide substrate made of a dense material such as glass has a shorter liquid supply channel and a faster liquid supply speed, but there is a greater risk of liquid leakage. Therefore, manufacturing the heating element 11 by using a liquid guide substrate made of a dense material such as glass often requires higher sealing performance for the vaporization component 1, which increases the difficulty and costs of manufacturing the vaporization component 1. Moreover, even if a structure such as a liquid storage groove is designed in the vaporization component 1 to collect the leaked liquid and prevent the leaked liquid from flowing out of the vaporization component 1, the utilization of the aerosol-forming medium is relatively low.

Further, the inventor of this disclosure has found that due to the relatively high resistivity of the existing material such as the nickel-chromium alloy, the nickel-chromium-iron alloy, or the iron-chromium-aluminum alloy, the thickness of the heating film is reduced to a few micrometers or less under the same shape, and the resistance of the heating film will increase significantly. For example, the thickness of the heating film is reduced from 100 micrometers to 10 micrometers, and the resistance of the heating film is increased by 10 times. If the power of the heating element 11 is to be kept constant, the voltage of the battery needs to be increased, which will lead to an increase in the costs of the electronic vaporization device. Moreover, such a heating element 11 cannot match the voltage of the battery in the power supply component 2 of the current electronic vaporization device, which leads to inconvenience for consumers to use.

Based on the problems of the existing heating element, this disclosure provides a heating element 11 to solve the above problems. The structure of the heating element 11 of this disclosure is to be described in detail below.

Referring to FIG. 3 and FIG. 4, FIG. 3 is a schematic structural diagram of a heating element of this disclosure, and FIG. 4 is a schematic structural diagram of a dense substrate in the heating element provided in FIG. 3.

The heating element 11 includes a dense substrate 111 and a heating film 112. The dense substrate 111 includes a first surface 1111 and a second surface 1112 opposite to the first surface 1111. A plurality of micro-pores 113 are arranged in the dense substrate 111, the micro-pores 113 are through holes, and each of the micro-pores 113 is configured to guide an aerosol-forming medium to the first surface 1111. The micro-pore 113 has the capillary action. The heating film 112 is formed on the first surface 1111, and the resistance of the heating film 112 at a normal temperature is in a range of 0.5 Ohms to 2 Ohms, where the normal temperature is 25° C. It may be understood that the dense substrate 111 plays a structural support role, and the heating film 112 in the heating element 11 is electrically connected to the power supply component 2. When the power of the electronic vaporization device is in a range of 6 watts to 8.5 watts, and the voltage of the battery is in a range of 2.5 volts to 4.4 volts, in order to achieve the operating resistance of the battery, the resistance of the heating film 112 of the heating element 11 at the room temperature is in a range of 0.5 Ohms to 2 Ohms.

In this disclosure, a plurality of micro-pores 113 with capillary force are arranged in the dense substrate 111, so that a magnitude of a porosity of the heating element 11 can be accurately controlled, thereby improving the consistency of products. That is to say, in mass production, the porosity of the dense substrate 111 in the heating element 11 is basically the same, and the thickness of the heating film 112 formed on the dense substrate 111 is uniform, so that the vaporization effects of the same batch of electronic vaporization devices are consistent.

The aerosol-forming medium in the liquid storage cavity 10 reaches the dense substrate 111 of the heating element 11 through the liquid flowing channel 14, and the aerosol-forming medium is guided to the first surface 1111 of the dense substrate 111 by using the capillary force of the micro-pore 113 in the dense substrate 111, so that the aerosol-forming medium is vaporized by the heating film 112. That is to say, the micro-pore 113 is in communicate with the liquid storage cavity 10 by the liquid flowing channel 14. A material of the dense substrate 111 may be glass or dense ceramic. When the dense substrate 111 is glass, the glass may be one of common glass, quartz glass, borosilicate glass, or photosensitive lithium aluminosilicate glass.

Compared with the existing cotton core heating element and the porous ceramic heating element, the heating element 11 with a micro-porous sheet structure provided in this disclosure has a shorter liquid supply channel and a faster liquid supply speed, but there is a greater risk of liquid leakage. Therefore, the inventor of this disclosure has studied the impact of the ratio of the thickness of the dense substrate 111 to a pore size of the micro-pore 113 on the liquid guiding of the heating element 11, and found that increasing the thickness of the dense substrate 111 and reducing the pore size of the micro-pore 113 can reduce the risk of liquid leakage but also reduces the liquid supply rate, and decreasing the thickness of the dense substrate 111 and increasing the pore size of the micro-pore 113 can increase the liquid supply rate but increase the risk of liquid leakage, which contradict each other. To this end, this disclosure designs the thickness of the dense substrate 111, the pore size of the micro-pore 113, and the ratio of the thickness of the dense substrate 111 to the pore size of the micro-pore 113, so that sufficient liquid supply can be realized, and liquid leakage can also be prevented when the heating element 11 operates at a power of 6 watts to 8.5 watts and a voltage of 2.5 volts to 4.4 volts. The thickness of the dense substrate 111 is a distance between the first surface 1111 and the second surface 1112.

In addition, the inventor of this disclosure has studied a ratio of a distance between centers of adjacent micro-pores 113 to the pore size of the micro-pore 113, and found that if the ratio of the distance between centers of adjacent micro-pores 113 to the pore size of the micro-pore 113 is too large, the dense substrate 111 has relatively high strength and is also easy to process, but a too small porosity may easily lead to insufficient liquid supply. If the ratio of the distance between centers of adjacent micro-pores 113 to the pore size of the micro-pore 113 is too small, the porosity is relatively large and the liquid supply is sufficient, but the dense substrate 111 has relatively low strength and is not easy to process. In this way, this disclosure further designs the ratio of the distance between centers of adjacent micro-pores 113 to the pore size of the micro-pore 113, so as to maximize the strength of the dense substrate 111 while satisfying the liquid supply capacity.

The material of the dense substrate 111 is glass for description below.

Specifically, the first surface 1111 and the second surface 1112 both include smooth surfaces, and the first surface 1111 is a plane. That is to say, the first surface 1111 of the dense substrate 111 is a smooth surface and is a plane, and the heating film 112 is formed on the first surface 1111. The first surface 1111 is a smooth surface, which is conducive to the deposition of a metal material with a small thickness into a film.

In an implementation, the first surface 1111 and the second surface 1112 of the dense substrate 111 are both smooth surfaces and both planes, and the first surface 1111 and the second surface 1112 of the dense substrate 111 are arranged in parallel. The micro-pore 113 extends through the first surface 1111 and the second surface 1112, an axis of the micro-pore 113 is perpendicular to the first surface 1111 and the second surface 1112, and a section of the micro-pore 113 is circular. In this case, the thickness of the dense substrate 111 is equal to a length of the micro-pore 113. It may be understood that the second surface 1112 is parallel to the first surface 1111, and the micro-pore 113 extends from the first surface 1111 to the second surface 1112, so that the production process of the dense substrate 111 is simple and the cost is reduced. The thickness of the dense substrate 111 is a distance between the first surface 1111 and the second surface 1112. The micro-pore 113 may be a straight through hole with a uniform pore size, or may be a straight through hole with non-uniform pore sizes, as long as a variation range of the pore size is within 50%. For example, due to the limitation of the manufacturing process, the micro-pore 113 formed on the glass by laser induction and etching usually has a large pore size on two ends and a small pore size in the middle. Therefore, it is only necessary to ensure that the pore size of the middle part of the micro-pore 113 is not less than half of the pore size of end openings on two ends.

In another implementation, the first surface 1111 of the dense substrate 111 is a smooth surface and is a plane, which is conducive to the deposition of a metal material with a small thickness into a film. The second surface 1112 of the dense substrate 111 is a smooth surface, and the second surface 1112 may be non-planar, for example, a slope, a cambered surface, a serrated surface, or the like. The second surface 1112 may be designed according to specific needs, and it is only necessary to cause the micro-pore 113 to extend through the first surface 1111 and the second surface 1112.

When the material of the dense substrate 111 is glass, and the first surface 1111 and the second surface 1112 of the dense substrate 111 are both smooth planes and are arranged in parallel, the thickness of the dense substrate 111, the ratio of the thickness of the dense substrate 111 to the pore size of the micro-pore 113, and the ratio of the distance between centers of two adjacent micro-pores 113 to the pore size of the micro-pore 113 are described below.

The thickness of the dense substrate 111 is in a range of 0.1 millimeters to 1 millimeter. When the thickness of the dense substrate 111 is greater than 1 mm, the liquid supply demand cannot be satisfied, resulting in a decrease in the amount of aerosol, a large amount of heat loss, and high costs of arranging the micro-pores 113. When the thickness of the dense substrate 111 is less than 0.1 mm, the strength of the dense substrate 111 cannot be guaranteed, which is not conducive to improvement in the performance of the electronic vaporization device. Preferably, the thickness of the dense substrate 111 is in a range of 0.2 millimeters to 0.5 millimeter. The pore size of the micro-pore 113 on the dense substrate 111 is in a range of 1 micrometer to 100 micrometers. When the pore size of the micro-pore 113 is less than 1 micrometer, the liquid supply demand cannot be satisfied, resulting in a decrease in the amount of aerosol. When the pore size of the micro-pore 113 is greater than 100 micrometers, the aerosol-forming medium easily flows out of the micro-pore 113 to the first surface 1111 to cause liquid leakage, resulting in a decrease in vaporization efficiency. Preferably, the pore size of the micro-pore 113 is in a range of 20 micrometers to 50 micrometers. It may be understood that the thickness of the dense substrate 111 and the pore size of the micro-pore 113 are selected according to actual needs.

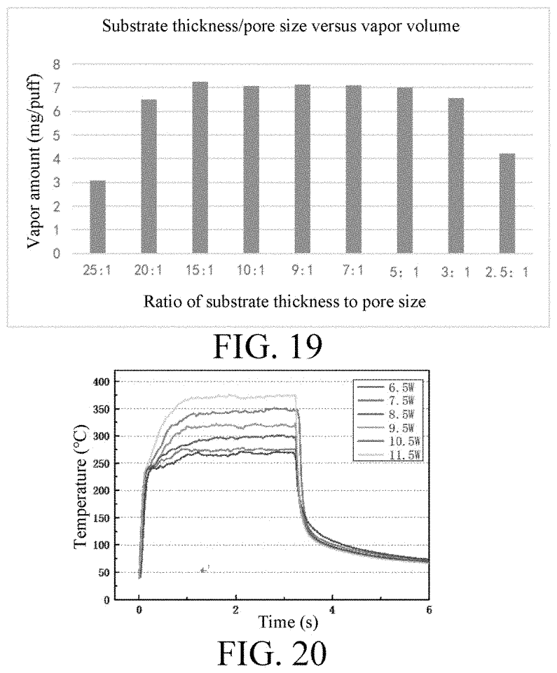

The ratio of the thickness of the dense substrate 111 to the pore size of the micro-pore 113 is in a range of 20:1-3:1. Preferably, the ratio of the thickness of the dense substrate 111 to the pore size of the micro-pore 113 is in a range of 15:1-5:1 (referring to FIG. 19, it is found through experiments that when the ratio of the thickness of the dense substrate 111 to the pore size of the micro-pore 113 is in a range of 15:1-5:1, the vaporization effect is desirable). When the ratio of the thickness of the dense substrate 111 to the pore size of the micro-pore 113 is greater than 20:1, the aerosol-forming medium supplied by the capillary force of the micro-pore 113 is difficult to satisfy the vaporization demand of the heating element 11, which not only easily leads to dry burning, but also reduces the amount of aerosol generated by a single vaporization. When the ratio of the thickness of the dense substrate 111 to the pore size of the micro-pore 113 is less than 3:1, the aerosol-forming medium easily flows out of the micro-pore 113 to the first surface 1111, and the aerosol-forming medium is wasted, resulting in a decrease in the vaporization efficiency and a decrease in a total amount of aerosol.

The ratio of the distance between centers of two adjacent micro-pores 113 to the pore size of the micro-pore 113 is in a range of 3:1-1.5:1, so that the micro-pore 113 on the dense substrate 111 can maximize the strength of the dense substrate 111 while satisfying the liquid supply capacity. Preferably, the ratio of the distance between centers of two adjacent micro-pores 113 to the pore size of the micro-pore 113 is in a range of 3:1-2:1. More preferably, the ratio of the distance between centers of two adjacent micro-pores 113 to the pore size of the micro-pore 113 is in a range of 3:1-2.5:1.

In a specific embodiment, preferably, the ratio of the thickness of the dense substrate 111 to the pore size of the micro-pore 113 is in a range of 15:1-5:1, and the ratio of the distance between centers of two adjacent micro-pores 113 to the pore size of the micro-pore 113 is in a range of 3:1-2.5:1.

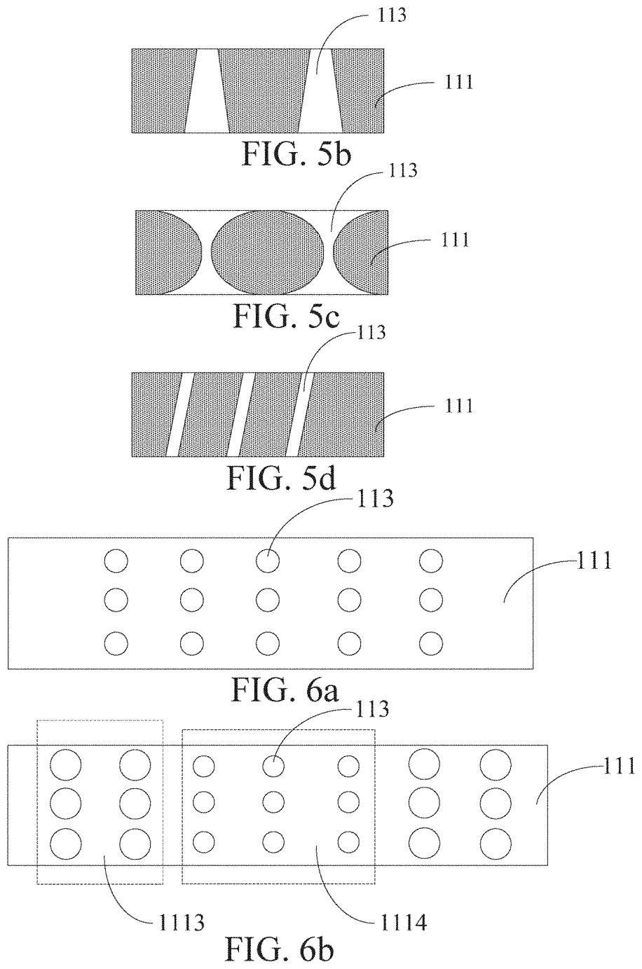

Referring to FIG. 5a, FIG. 5b, FIG. 5c, and FIG. 5d, FIG. 5a is a schematic structural diagram of a first implementation of a micro-pore in the dense substrate provided in FIG. 3, FIG. 5b is a schematic structural diagram of a second implementation of a micro-pore in the dense substrate provided in FIG. 3, FIG. 5c is a schematic structural diagram of a third implementation of a micro-pore in the dense substrate provided in FIG. 3, and FIG. 5d is a schematic structural diagram of a fourth implementation of a micro-pore in the dense substrate provided in FIG. 3.

In other implementations, the micro-pore 113 may further be arranged to have other structures, referring to FIG. 5a, FIG. 5b, FIG. 5c, and FIG. 5d. An extending direction of the micro-pore 113 is perpendicular to a thickness direction of the dense substrate 111. Specifically, a longitudinal section of the micro-pore 113 may be in a rectangle shape (as shown in FIG. 5a), a trapezoid shape (as shown in FIG. 5b), a dumbbell shape big on two ends and small in the middle (as shown in FIG. 5c), and the like. In another implementation, an included angle is formed between the extending direction of the micro-pore 113 and the thickness direction of the dense substrate 111, and the included angle ranges from 80 degrees to 90 degrees. When the longitudinal section of the micro-pore 113 is in a rectangle shape, the structure is shown in FIG. 5d. Since the micro-pore 113 is arranged in a regular geometric shape, a volume of the micro-pore 113 in the heating element 11 can be calculated, and the porosity of the whole heating element 11 can also be calculated, so that the consistency of the porosities of the heating elements 11 of similar products can be well guaranteed.

Referring to FIG. 6a and FIG. 6b, FIG. 6a is a schematic structural top view of a first implementation of the dense substrate provided in FIG. 3, and FIG. 6b is a schematic structural top view of a second implementation of the dense substrate provided in FIG. 3.

Specifically, the dense substrate 111 is in a regular shape such as a rectangular plate shape, a circular plate shape, and the like. In this implementation, a plurality of micro-pores 113 arranged in the dense substrate 111 are arranged in an array. That is, a plurality of micro-pores 113 arranged in the dense substrate 111 are regularly arranged, and distances between centers of adjacent micro-pores 113 in the plurality of micro-pores 113 are the same. Optionally, the plurality of micro-pores 113 are arranged in a rectangular array, or the plurality of micro-pores 113 are arranged in a circular array, or the plurality of micro-pores 113 are arranged in a hexagonal array. Pore sizes of the plurality of micro-pores 113 may be the same or different, and are designed as required.

In an implementation, the dense substrate 111 is in the shape of a rectangular plate, and the plurality of micro-pores 113 arranged in the dense substrate 111 have the same shape and pore size and are arranged in a rectangular array, as shown in FIG. 6a.

In another implementation, the dense substrate 111 is in the shape of a rectangular plate. The first surface 1111 of the dense substrate 111 includes a first-pore-size micro-pore array region 1113 and a second-pore-size micro-pore array region 1114. The pore size of each of the micro-pore 113 in the second-pore-size micro-pore array region 1114 is different from the pore size of the micro-pore 113 in the first-pore-size micro-pore array region 1113, and the shape of the micro-pore 113 in the second-pore-size micro-pore array region 1114 is the same as the shape of the micro-pore 113 in the first-pore-size micro-pore array region 1113. The micro-pore 113 in the second-pore-size micro-pore array region 1114 and the micro-pore 113 in the first-pore-size micro-pore array region 1113 are both arranged in a rectangular array. The first-pore-size micro-pore array region 1113 is arranged on two sides of the second-pore-size micro-pore array region 1114. The pore size of the micro-pore 113 in the second-pore-size micro-pore array region 1114 is less than the pore size of the micro-pore 113 in the first-pore-size micro-pore array region 1113, as shown in FIG. 6b. It may be understood that the second-pore-size micro-pore array region 1114 is arranged on two sides of the first-pore-size micro-pore array region 1113, and the pore size of the micro-pore 113 in the second-pore-size micro-pore array region 1114 is less than the pore size of the micro-pore 113 in the first-pore-size micro-pore array region 1113. The first-pore-size micro-pore array region 1113, the second-pore-size micro-pore array region 1114, and the micro-pores 113 arranged in the micro-pore array regions are designed as required.

In other implementations, an axis of the micro-pore 113 is not perpendicular to the first surface 1111 and the second surface 1112. One end opening of the micro-pore 113 is located on the first surface 1111, and another end opening of the micro-pore 113 may be located on a third surface (not shown) connecting the first surface 1111 to the second surface 1112. Alternatively, another end opening of the micro-pore 113 is located on the second surface 1112, and the micro-pore 113 extends in a curve. The structure of the micro-pore 113 may be designed as required, and the aerosol-forming medium can be guided to the first surface 1111 by the capillary force of the micro-pore.

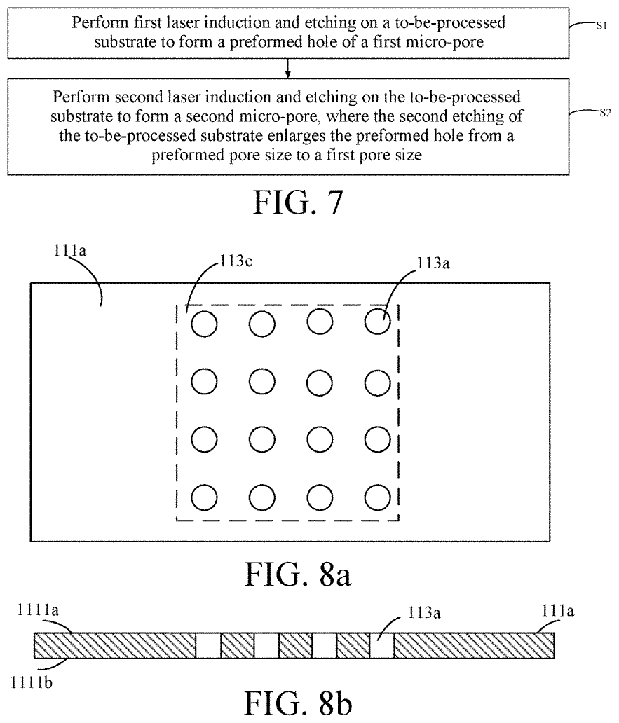

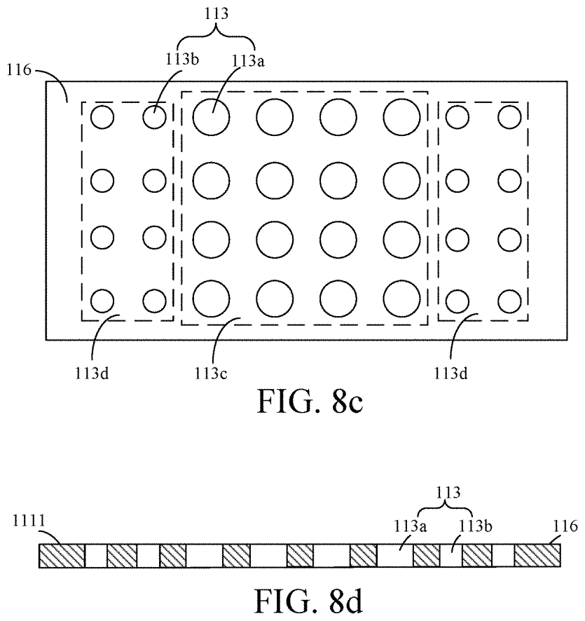

Referring to FIG. 7, FIG. 7 is a schematic flowchart of a manufacturing process of the dense substrate provided in FIG. 6b. FIG. 8a is a schematic structural top view of step S1 in FIG. 7. FIG. 8b is a schematic structural side view of step S1 in FIG. 7. FIG. 8c is a schematic structural top view of step S2 in FIG. 7. FIG. 8d is a schematic structural side view of step S2 in FIG. 7.

In an embodiment, the dense substrate is glass, which is referred to as a liquid guide glass substrate. The manufacturing method of the liquid guide glass substrate includes the following steps: Step S1: Perform first laser induction and etching on a to-be-processed substrate to form a pre-formed hole of a first micro-pore.

Specifically, referring to FIG. 8a to FIG. 8b, a to-be-processed substrate 111a is provided. The to-be-processed substrate 111a includes a first surface 1111a and a second surface 1111b opposite to the first surface 1111a. First laser induction is performed on the to-be-processed substrate 111a, and the to-be-processed substrate 111a after the first laser induction is immersed in an etching solution to form a pre-formed hole of a first micro-pore 113a. The pre-formed hole of the first micro-pore 113a have a predetermined pore size, and the pre-formed hole extends through the first surface 1111a and the second surface 1111b.

After step S1, a first micro-pore array 113c including a plurality of pre-formed holes with predetermined pore sizes is formed on the to-be-processed substrate 111a.

Step S2: Perform second laser induction and etching on the to-be-processed substrate to form a second micro-pore, the second micro-pore having a second pore size, where the second etching of the to-be-processed substrate enlarges the pre-formed hole of the first micro-pore from the predetermined pore size to a first pore size.

Specifically, referring to FIG. 8c to FIG. 8d, second laser induction is performed on the to-be-processed substrate 111a based on the second pore size, the to-be-processed substrate 111a after the second laser induction is immersed in an etching solution to form a second micro-pore 113b, and the second micro-pore 113b has a second pore size. The second etching of the to-be-processed substrate 111a enlarges the pre-formed hole of the first micro-pore 113a from the predetermined pore size to the first pore size. In addition, the first micro-pore 113a extends through the first surface 1111a and the second surface 1111b, so as to obtain a liquid guide glass substrate 116 of micro-pores 113 with different pore sizes that function to guide a liquid.

After step S2, a second micro-pore array 113d including a plurality of second micro-pores 113b with a second pore size and a first micro-pore array 113c including a plurality of first micro-pores 113a with a first pore size are formed in the liquid guide glass substrate 116.

In a specific embodiment, in order to control the pore size of the first micro-pore 113a and the second micro-pore 113b, the manufacturing method of the dense substrate includes the following steps.

S11: Perform laser induction on a to-be-processed substrate according to distribution of the first micro-pores with a predetermined pore size (i.e. a third pore size).

Referring to FIG. 8a to FIG. 8b, a material of the to-be-processed substrate 111a is glass, and the glass may be one or more of borosilicate glass, quartz glass, or photosensitive lithium aluminosilicate glass. The to-be-processed substrate 111a includes a first surface 1111a and a second surface 1111b opposite to the first surface 1111a. First illumination is performed, according to the first pore size, on the to-be-processed substrate 111a by using infrared picosecond laser or femtosecond laser with a frequency of 100 kHz to 200 kHz and a pulse width of less than 10 picoseconds. In the step, the materials of the to-be-processed substrate 111a within a first pore size range are induced by laser and can be removed in the subsequent etching process.

S12: Perform first etching on the substrate after the first laser induction, where the first etching time is a total etching time (N) required for the first micro-pore with the first pore size minus an etching time (M) required for the second micro-pore with a second pore size.

Specifically, the to-be-processed substrate 111a after the first laser induction is immersed in the etching solution with a temperature of 30° C. to 60° C., and the etching solution can be selected from an acidic etching solution such as a hydrofluoric acid solution, or an alkaline etching solution such as a sodium hydroxide solution. The etching rate of the laser-modified part is several tens of times larger than that of the unmodified part. Therefore, a pre-formed hole with a predetermined pore size is formed on the to-be-processed substrate 111a, and the pre-formed hole extends through the first surface 1111a and the second surface 1111b.

Specifically, before the manufacturing, it is determined through experiments that it takes N minutes to etch the first micro-pore 113a with the first pore size, and that it takes M minutes to etch the second micro-pore 113b with the second pore size. In this step, the first etching time is N-M minutes. That is to say, N is the total etching time for forming the first micro-pore 113a with the first pore size, M is the second etching time for forming the second micro-pore 113b with the second pore size, and N-M is a time difference between the etching time for forming the first micro-pore 113a with the first pore size and the second etching time for forming the second micro-pore 113b with the second pore size.

In other specific embodiments, the first etching is performed on the to-be-processed substrate 111a in etching manners such as spraying, stirring, and air blasting, so that the etching solution is fully exchanged and flow, and a sidewall of the etched first micro-pore 113a is more uniform and smoother. Further, the temperature of the etching solution is preheated to between 30° C. and 60° C., so as to speed up the etching rate.

In a specific embodiment, through steps S11 and S12, the first micro-pore array 113c including the plurality of pre-formed holes with predetermined pore sizes is formed on the to-be-processed substrate 111a.

S13: Perform laser induction on the to-be-processed substrate according to the second pore size.

Referring to FIG. 8c to FIG. 8d, second illumination is performed on the to-be-processed substrate 111a after the first laser induction and etching (i.e. the pre-etching) according to the second pore size by using infrared picosecond laser or femtosecond laser with a frequency of 100 kHz to 200 kHz and a pulse width of less than 10 picoseconds. A region for the second illumination is different from a region for the first illumination. In the step, the materials of the to-be-processed substrate 111a within a second pore size range are induced by laser and can be removed in the subsequent etching process.

S14: Perform second etching on the substrate after the second laser induction for a time being the etching time (M) required for the second micro-pore with the second pore size.

In the step, the to-be-processed substrate 111a after the second laser induction is immersed in the etching solution for M minutes, and the second micro-pore 113b with the second pore size is formed in the to-be-processed substrate 111a. The second etching of the to-be-processed substrate 111a enlarges the pre-formed hole from the predetermined pore size to the first pore size, so as to form the first micro-pore 113a. Specifically, the to-be-processed substrate 111a is immersed in the etching solution twice, the thickness of the to-be-processed substrate is reduced to a certain extent, and the first micro-pore 113a and the second micro-pore 113b extend through the first surface 1111a and the second surface 1111b, thereby obtaining the liquid guide glass substrate 116 having micro-pores 113 with different pore sizes that function to guide a liquid. It may be understood that when the liquid guide glass substrate 116 is made of glass such as borosilicate glass, quartz glass, or photosensitive lithium aluminosilicate glass or dense ceramic, the liquid guide glass substrate is the dense substrate 111.

In a specific embodiment, through step S13 and S14, the second micro-pore array 113d including the plurality of second micro-pores 113b with the second pore size and the first micro-pore array 113c including the plurality of first micro-pores 113a with the first pore size are formed on the liquid guide glass substrate 116.

Since the dense substrate 111 in the heating element 11 is made of a dense material, the dense substrate can serve as structural support. Compared with the spring-shaped metal heating wire of the existing cotton core heating element and the thick-film metal wire of the porous ceramic heating element, there is no requirement for the strength and the thickness of the heating film 112 in the heating element 11, and the heating film 112 may be made of a low resistivity metal material.

In an implementation, the heating film 112 formed on the first surface 1111 of the dense substrate 111 is a thin film, and the thickness of the heating film 112 ranges from 200 nanometers to 5 micrometers, that is, the thickness of the heating film 112 is relatively small. Preferably, the thickness of the heating film 112 ranges from 200 nanometers to 1 micrometer. More preferably, the thickness of the heating film 112 ranges from 200 nanometers to 500 nanometers. When the heating film 112 is a thin film, the micro-pore 113 extends through the heating film 112. Further, the heating film 112 is further formed on an inner surface of the micro-pore 113. Preferably, the heating film 112 is further formed on the entire inner surface of the micro-pore 113 (the structure is shown in FIG. 3). The heating film 112 is arranged on the inner surface of the micro-pore 113, so that the aerosol-forming medium can be vaporized in the micro-pore 113, which is beneficial to improve the vaporization effect.

A thinner heating film 112 leads to less impact on the pore size of the micro-pore 113, thereby achieving a better vaporization effect. A thinner heating film 112 leads to less heat absorbed by the heating film 112. A lower electric heat loss leads to a faster heat-up speed of the heating element 11. On the basis that the resistance of the heating film 112 at a room temperature is in a range of 0.5 Ohms to 2 Ohms, a low-conductivity metal material is used in this disclosure to form a thinner metal film and minimize the impact on the pore size of the micro-pore 113. Optionally, the resistance of the heating film 112 is not greater than 0.06×10⁻⁶ Ωm. The low-conductivity metal material of the heating film 112 include silver and its alloys, copper and its alloys, aluminum and its alloys, and gold and its alloys. Optionally, the material of the heating film 112 may include aluminum and its alloys and gold and its alloys. During heating after energized, the heating film 112 can heat up rapidly and directly heat the aerosol-forming medium in the micro-pore 113, thereby achieving efficient vaporization.

Further, the inventor of this disclosure has found that the liquid aerosol-forming medium contains various flavors and fragrances and additives, and contains elements such as sulfur, phosphorus, and chlorine. When the heating film 122 is energized and heated, silver and copper are prone to corrosion and failure. Gold has very strong chemical inertness, and a dense oxide film is formed on a surface of aluminum. These two materials are very stable in the liquid aerosol-forming medium, and are preferably used as the material of the heating film 122.

The heating film 112 may be formed on the first surface 1111 of the dense substrate 111 by physical vapor deposition (for example, magnetron sputtering, vacuum evaporation, or ion plating) or chemical vapor deposition (ion-assisted chemical deposition, laser-assisted chemical deposition, or metal organic compound deposition). It may be understood that the heating film 112 is formed in such a process that the heating film does not cover the micro-pore 113, that is, the micro-pore 113 extends through the heating film 112. When the heating film 112 is formed on the first surface 1111 of the dense substrate 111 by physical vapor deposition or chemical vapor deposition, the heating film 112 is also formed on the inner surface of the micro-pore 113. When the heating film 112 is formed on the first surface 1111 of the dense substrate 111 by magnetron sputtering, metal atoms are perpendicular to the first surface 1111 and parallel to the inner surface of the micro-pore 113 during magnetron sputtering, and the metal atoms are easier to deposit on the first surface 1111. Assuming that the thickness of the heating film 112 formed by depositing metal atoms on the first surface 1111 is 1 micrometer, the thickness of the metal atoms deposited on the inner surface of the micro-pore 113 is much less than 1 micrometer, even less than 0.5 micrometers. A smaller thickness of the heating film 112 deposited on the first surface 1111 leads to a smaller thickness of the heating film 112 formed on the inner surface of the micro-pore 113 and less impact on the pore size of the micro-pore 113. Since the thickness of the heating film 112 is much smaller than the pore size of the micro-pore 113, and a thickness of a part of the heating film 112 deposited in the micro-pore 113 is smaller than a thickness of a part deposited on the first surface 1111 of the dense substrate 111, the deposition of the heating film 112 in the micro-pore 113 has a negligible effect on the pore size of the micro-pore 113.

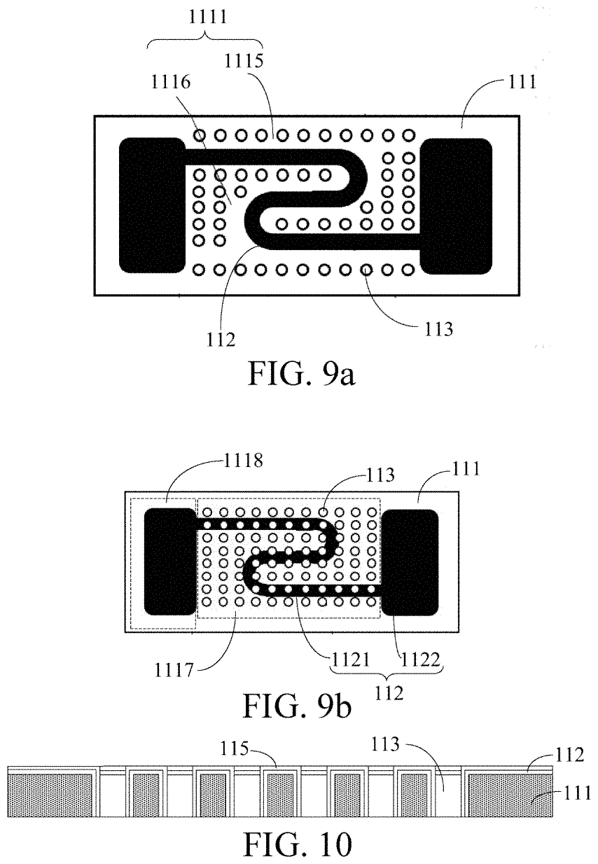

In another implementation, the heating film 112 formed on the first surface 1111 of the dense substrate 111 is a thick film, and the thickness of the heating film 112 ranges from 5 micrometers to 100 micrometers, preferably, 5 micrometers to 50 micrometers. On the basis that the resistance of the heating film 112 is 0.5 Ohms to 2 Ohms, the material of the heating film 112 includes one of a nickel-chromium alloy, a nickel-chromium-iron alloy, an iron-chromium-aluminum alloy, nickel, platinum, or titanium. The heating film 112 is formed on the first surface 1111 of the dense substrate 111 by printing. Since the roughness of the first surface 1111 of the dense substrate 111 is low, the heating film 112 can be formed into a continuous film shape with a thickness of 100 micrometers. In this case, the first surface 1111 of the dense substrate 111 includes a micro-porous pattern region 1115 and a non-micro-porous pattern region 1116, and the heating film 112 is formed in the non-micro-porous pattern region 1116. That is to say, the micro-pore 113 is not provided on the first surface 1111 of the dense substrate 111 where the heating film 112 is arranged, so as to ensure the stability and consistency of the heating film 112. (As shown in FIG. 9a, FIG. 9a is a schematic structural top view showing that a heating film in a heating element according to this disclosure is a thick film).

Referring to FIG. 9, FIG. 9b is a schematic structural top view of the heating element provided in FIG. 3.

The shape of the heating film 112 may be a sheet shape, a mesh shape, or a strip shape. The sheet shape and the strip shape in this disclosure mean that the heating film 112 have different length-diameter ratios. If the length-diameter ratio is greater than 2, the shape of the heating film may be deemed to be strip-shaped, and if the length-diameter ratio is less than 2, the shape of the heating film may be deemed to be sheet-shaped. Under the condition of the same material and thickness, the resistance of the strip-shaped heating film 112 is greater than the resistance of the sheet-shaped heating film 112. When the heating film 112 is in a sheet shape, the heating film 112 can cover the entire first surface 1111, and a temperature field formed on the first surface 1111 of the dense substrate 111 is uniform. Since the aerosol-forming medium usually contains a plurality of components, the temperature field is uniform, which is not conducive to the reduction of the aerosol-forming medium. When the heating film 112 is strip-shaped, the heating film 112 only covers part of the first surface 1111, and the heating film 112 forms a temperature field with a gradient on the first surface 1111 of the dense substrate 111. The temperature field with a gradient respectively includes boiling temperatures of different components in the aerosol-forming medium, so that each component in the aerosol-forming medium is vaporized at a boiling point of the component to achieve better vaporization effect, which can help improve the degree of reduction of the aerosol-forming medium. When the heating film 112 is grid-shaped, the size of the grid determines whether the temperature field formed by the heating film 112 on the first surface 1111 of the dense substrate 111 is uniform, and the size of the grid is designed as required. Even if the size of the grid is set so that the heating film 112 can form a temperature field with a temperature gradient on the first surface 1111 of the dense substrate 111, the vaporization effect of the grid-shaped heating film is not better than that of the strip-shaped heating film 112.

In other implementations, when the heating film 112 is sheet-shaped, the heating film 112 can cover the entire first surface 1111. By causing the thicknesses of the heating films 112 in different regions to be uneven or the materials of the heating films 112 in different regions to be different, the heating film 112 forms a temperature field with a gradient on the first surface 1111 of the dense substrate 111. It may be understood that the heating film 112 is deposited by physical vapor deposition or chemical vapor deposition, and the heating film 112 with a gradient thickness can be easily realized by adjusting a positional relationship between the dense substrate 111 and a material source.

The heating film 112 is strip-shaped for description, and the structure is shown in FIG. 9b. The dense substrate 111 is in the shape of a rectangular plate, and the heating film 112 includes a heating film body 1121 and an electrode 1122. The electrode 1122 includes a positive electrode and a negative electrode. In order to achieve a better vaporization effect, the heating film body 1121 is designed as a curved S-shaped strip, so as to form a temperature field with a temperature gradient on the first surface 1111 of the dense substrate 111. That is to say, a high temperature region and a low temperature region are formed on the first surface 1111 of the dense substrate 111, so as to maximize the vaporization of various components in the aerosol-forming medium. One end of the heating film body 1121 is connected to the positive electrode, and an other end of the heating film body is connected to the negative electrode. A size of the electrode 1122 is larger than a size of the heating film body 1121, so that the electrode 1122 can be more effectively electrically connected to the power supply component 2. In this implementation, the heating film body 1121 and the electrode 1122 are integrally formed, that is, a material of the heating film body 1121 is the same as a material of the electrode 1122. In other implementations, the material of the heating film body 1121 and the material of the electrode 1122 may be different, as long as the functions can be achieved.

The inventor of this disclosure has found that, since the strip-shaped heating film 112 is a strip-shaped elongated structure, the resistance of the strip-shaped heating film is higher than that of the sheet-shaped heating film 112 under the same condition. Therefore, in order to manufacture a strip-shaped heating film 112 with a thickness of nanometers, especially a thickness of 200 nanometers to 500 nanometers, the material of the heating film 112 can only be selected from aluminum, gold, silver, and copper with the resistivity not greater than 0.03×10⁻⁶ Ωm.

The first surface 1111 of the dense substrate 111 includes a micro-porous region 1117 and a non-micro-porous region 1118. The electrode 1122 is arranged in the non-micro-porous region 1118, and the heating film body 1121 is arranged in the micro-porous region 1117. Since the heating film 112 shown in FIG. 9b is a thin film, some of the micro-pores 113 extend through the heating film body 1121.

It may be understood that when the pore sizes of the plurality of micro-pores 113 arranged in the dense substrate 111 are different, the micro-porous region 1117 includes a first-pore-size micro-pore array region 1113 and a second-pore-size micro-pore array region 1114. The pore size of the micro-pore 113 in the first-pore-size micro-pore array region 1113 is the same, the pore size of the micro-pore 113 in the second-pore-size micro-pore array region 1114 is the same, and the pore size of the micro-pore 113 in the first-pore-size micro-pore array region 1113 and the pore size of the micro-pore 113 in the second-pore-size micro-pore array region 1114 are different, which are specifically designed as required. When the heating film 112 formed on the first surface 1111 of the dense substrate 111 is a thick film, the heating film body 1121 is arranged in the micro-porous region 1117, and the electrode 1122 is arranged in the non-micro-porous region 1118. Due to the process condition for forming the thick heating film 112, the micro-pore 113 is not arranged in the micro-porous region 1117 where the heating film body 1121 is arranged. That is, the micro-porous region 1117 includes a micro-porous pattern region 1115 and a non-micro-porous pattern region 1116, and the heating film body 1121 is arranged in the non-micro-porous pattern region 1116.

As described above, in order to manufacture the heating film 112 with a thickness of less than 5 micrometers or even a nanoscale heating film, aluminum, gold, silver, and copper are preferred materials. However, the heating film 112 made of silver and copper is easily corroded in the liquid aerosol-forming medium and fails. In addition, the heating film 112 made of aluminum also has the risk of failure during long-term high-power use. Therefore, the inventor of this disclosure has studied the protective layer of the heating film 112 and found the existing oxide protective layer and nitride protective layer. For example, a thermal expansion coefficient of silicon dioxide differs greatly from a thermal expansion coefficient of metal, and an internal stress between film layers during thermal cycling can cause the protective layer to fail rapidly. Moreover, an oxide and a nitride have poor conductivity. When the oxide or the nitride is used as a protective layer, if the heating film and the electrode are covered, the electrode may electrically contact a lead or an ejector pin. If the electrode is not covered, the manufacturing process is complicated. In order to solve the above problems, this disclosure further provides a protective film 115 on the heating film 112 of the heating element 11.

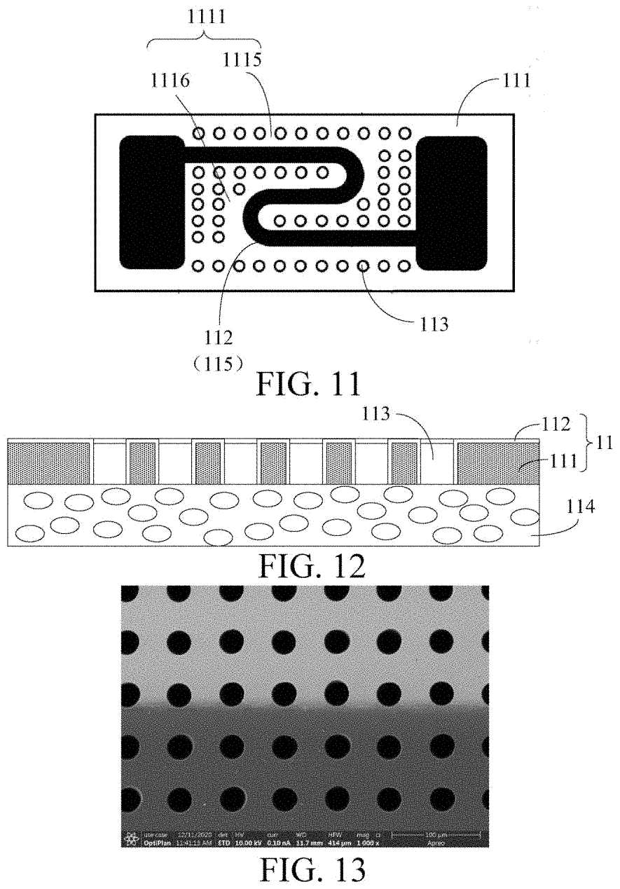

Referring to FIG. 10 and FIG. 11, FIG. 10 is a schematic structural diagram showing that a heating element according to this disclosure includes a protective film and the heating film is a thin film, and FIG. 11 is a schematic structural top view showing that a heating element according to this disclosure includes a protective film and the heating film is a thick film.

Further, the heating element 11 further includes the protective film 115. The protective film 115 is formed on a surface of the heating film 112 away from the dense substrate 111, and the material of the protective film 115 is a metal alloy resistant to the etching of the aerosol-forming medium, so as to prevent the aerosol-forming medium from corroding the heating film 112 and protect the heating film 112, thereby improving the performance of the electronic vaporization device.

When the heating film 112 is a thin film (the structure is shown in FIG. 10), the thickness of the heating film 112 is in a range of 200 nanometers to 5 micrometers, and the resistivity of the heating film 112 is not greater than 0.06×10⁻⁶ Ωm. The material of the heating film 112 is copper and its alloys, silver and its alloys, aluminum and its alloys, and gold and its alloys, and the heating film 112 is formed on the first surface 1111 of the dense substrate 111 by physical vapor deposition or chemical vapor deposition. Optionally, the material of the heating film 112 is one of copper, silver, aluminum, gold, an aluminum alloy, or an aluminum-gold alloy. The thickness of the protective film 115 is 100 nanometers to 1000 nanometers, and the material of the protective film 115 is one of stainless steel, a nickel-chromium-iron alloy, or a nickel-based corrosion-resistant alloy. The stainless steel may be 304 stainless steel, 316L stainless steel, 317L stainless steel, 904L stainless steel, or the like, the nickel-chromium-iron alloy may be inconel625, inconel718, or the like, and the nickel-based corrosion-resistant alloy may be nickel-molybdenum alloy B-2, nickel-chromium-molybdenum alloy C-276, or the like. Preferably, the material of the protective film 115 is stainless steel. The protective film 115 is formed on the surface of the heating film 112 away from the dense substrate 111 by physical vapor deposition (for example, magnetron sputtering, vacuum evaporation, or ion plating) or chemical vapor deposition (ion-assisted chemical deposition, laser-assisted chemical deposition, or metal organic compound deposition). It may be understood that the heating film 112 and the protective film 115 are formed in such a process that the heating film and the protective film do not cover the micro-pore 113, that is, the micro-pore 113 extends through the heating film 112 and the protective film 115. Since the protective film 115 can effectively prevent the aerosol-forming medium from corroding the heating film 112, the heating film 112 may be made of copper and silver, so as to manufacture a nanoscale heating film 112.

When the heating film 112 is a thick film (the structure is shown in FIG. 11), the thickness of the heating film 112 is in a range of 5 micrometers to 100 micrometers, and the material of the heating film 112 is one of the nickel-chromium alloy, the nickel-chromium-iron alloy, the iron-chromium-aluminum alloy, gold, silver, nickel, platinum, or titanium. The thickness of the protective film 115 is 5 micrometers to 20 micrometers, and the material of the protective film 115 is one of stainless steel, a nickel-chromium-iron alloy, or a nickel-based corrosion-resistant alloy. The stainless steel may be 304 stainless steel, 316L stainless steel, 317L stainless steel, 904L stainless steel, or the like, the nickel-chromium-iron alloy may be inconel625, inconel718, or the like, and the nickel-based corrosion-resistant alloy may be nickel-molybdenum alloy B-2, nickel-chromium-molybdenum alloy C-276, or the like. Preferably, the material of the protective film 115 is stainless steel. When both the heating film 112 and the protective film 115 are sequentially formed on the first surface 1111 of the dense substrate 111 by printing, the material of the heating film 112 is one of the nickel-chromium alloy, the nickel-chromium-iron alloy, the iron-chromium-aluminum alloy, nickel, platinum, or titanium, and the material of the protective film 115 is stainless steel. When the heating film 112 is formed on the first surface 1111 of the dense substrate 111 by printing, and the protective film 115 is formed on the surface of the heating film 112 away from the dense substrate 111 by physical vapor deposition or chemical vapor deposition, the material of the heating film 112 is one of the nickel-chromium alloy, the nickel-chromium-iron alloy, the iron-chromium-aluminum alloy, nickel, platinum, or titanium, and the material of the protective film 115 is one of the stainless steel, the nickel-chromium-iron alloy, or the nickel-based corrosion-resistant alloy. The protective film 115 is arranged on the surface of the thick heating film 112, so that the aerosol-forming medium can be prevented from corroding the heating film 112.

The protective film 115 is arranged on the surface of the heating film 112, and the protective film 115 is a metal alloy. Theoretically, when the heating film 112 generates heat, the protective film 115 also generates heat. Since the resistance of the protective film 115 is much larger than the resistance of the heating film 112, the protective film 115 hardly generates heat, and the heating film 112 mainly heats and vaporizes the aerosol-forming medium. For example, the resistance of the heating film 112 is about 1 Ohm, the protective film 115 is made of stainless steel, the resistance of the protective film 115 is about 30 Ohms, the resistance of the protective film 115 is too large, and the resistance of the protective film 115 is much larger than the resistance of the heating film 112. Under the condition that the power of the electronic vaporization device is in a range of 6 watts to 8.5 watts, and the voltage of the battery is in a range of 2.5 volts to 4.4 volts, the protective film 115 cannot play the role of the heating film 112, that is, the protective film 115 cannot heat and vaporize the aerosol-forming medium.

In this disclosure, the heating film 112 includes the heating film body 1121 and the electrode 1122. The material of the heating film body 1121 is the same as the material of the electrode 1122. The protective film 115 is arranged on both the surface of the heating film body 1121 and the surface of the electrode 1122. It may be understood that the protective film 115 is only formed on the heating film body 1121, and the protective film 115 is not arranged on the electrode 1122, so as to reduce the resistance of the electrode 1122, thereby reducing the resistance consumption between the electrode 1122 and the ejector pin of the power supply component 2. That is to say, the protective film 115 partially exposes the heating film 112 to serve as the electrode 1122 of the heating film 112.

Further, the electrode 1122 may be arranged to be made of a material different from that of the heating film body 1121, so that the resistance of the electrode 1122 is relatively low, so as to reduce the resistance consumption between the electrode 1122 and the ejector pin of the power supply component 2.

It may be understood that the thickness of the dense substrate 111, the pore size of the micro-pore 113, the ratio of the thickness of the dense substrate 111 to the pore size of the micro-pore 113, and the ratio of the distance between the centers of the adjacent micro-pores 113 to the pore size of the micro-pore 113 may be combined as required. The dense substrate 111 may be combined with the thin heating film 112 (the thickness of the heating film 112 is in a range of 200 nanometers to 5 micrometers, the resistivity of the heating film 112 is not greater than 0.06×10⁻⁶Ωm, and the material of the heating film 112 is copper and its alloys, silver and its alloys, aluminum and its alloys, or gold and its alloys) or the thick heating film 112 (the thickness of the heating film 112 is in a range of 5 micrometers to 100 micrometers, and the material of the heating film 112 is one of the nickel-chromium alloy, the nickel-chromium-iron alloy, the iron-chromium-aluminum alloy, nickel, platinum, or titanium) as required. The protective film 115 may be designed as required. The protective film 115 in the heating element 11 provided in this disclosure may be applicable to the surface of a conventional porous ceramic heating element, so as to protect the heating film of the heating element.

Referring to FIG. 12, FIG. 12 is a partial schematic structural diagram of a vaporization component according to this disclosure including a loose substrate.

Further, the vaporization component 1 further includes a loose substrate 114. The loose substrate 114 is arranged on a second surface 1112 of a dense substrate 111 of the heating element 11. The loose substrate 114 may be made of a material selected from porous ceramic, a sponge, foam, and a fiber layer, which can achieve the effects of liquid storage, liquid guide, and thermal insulation. That is to say, the aerosol-forming medium in the liquid storage cavity 10 is first guided to the second surface 1112 of the dense substrate 111 through the loose substrate 114, and then guided to the first surface 1111 of the dense substrate 111 through the micro-pore 113 on the dense substrate 111 to be vaporized by the heating film 112.

The effects brought by the arrangement of the micro-pore 113 on the dense substrate 111, the selection of the material of the heating film 112, and the protective film 115 provided in this disclosure are verified through experiments.

Experiment I: A material is selected when the heating film 112 is a thin film.

A common pattern of the heating film 112 in the industry is used as an example (the shape of the heating film 112 shown in FIG. 9b). A length of the heating film 112 is 8.5 mm, and a width of the heating film is 0.4 mm. The resistance is 1 Ohm at a room temperature, and the heating film 112 is made of different materials. Required theoretical thicknesses of the heating film 112 can be obtained according to the resistivity of different metal materials, which are shown in Table 1.

TABLE 1
Resistivity of metal materials and the theoretical thickness of the heating film

| | | Thermal | Wire | Wire | | Theoretical |
|---|---|---|---|---|---|---|
| | Resistivity | conductivity | length | width | Resistance | thickness |
| Material | μΩm | W/mK | mm | mm | Ω | μm |
| Silver | 0.0165 | 429 | 8.5 | 0.4 | 1 | 0.35 |
| Copper | 0.0172 | 401 | 8.5 | 0.4 | 1 | 0.37 |
| Gold | 0.024 | 317 | 8.5 | 0.4 | 1 | 0.51 |
| Aluminum | 0.0283 | 238 | 8.5 | 0.4 | 1 | 0.60 |
| Tungsten | 0.0565 | 173 | 8.5 | 0.4 | 1 | 1.20 |
| Nickel | 0.0684 | 91 | 8.5 | 0.4 | 1 | 1.45 |
| Iron | 0.0971 | 80 | 8.5 | 0.4 | 1 | 2.06 |
| Platinum | 0.106 | 74 | 8.5 | 0.4 | 1 | 2.25 |
| Titanium | 0.42 | 22.4 | 8.5 | 0.4 | 1 | 8.93 |
| Nickel-chromium | 1.09 | 16.7 | 8.5 | 0.4 | 1 | 23.16 |
| alloy | | | | | | |
| Nickel-chromium- | 1.15 | 14.7 | 8.5 | 0.4 | 1 | 24.44 |
| iron alloy | | | | | | |
| Iron-chromium- | 1.25 | 14.4 | 8.5 | 0.4 | 1 | 26.56 |
| aluminum alloy | | | | | | |

According to Table 1, when the conventional nickel-chromium alloy, the nickel-chromium-iron alloy, and the iron-chromium-aluminum alloy are used, the theoretical thickness of the heating film 112 needs to exceed 20 μm, which may seriously affect the vaporization efficiency. During the deposition, the pore size of the micro-pore 113 in the dense substrate 111 may further be reduced, which affects the supply and vaporization of the aerosol-forming medium. When a low-resistivity metal material such as silver, copper, gold, or aluminum is adopted, the theoretical thickness of the heating film 112 is less than 1 μm, which not only has no impact on the pore size of the micro-pore 113 in the dense substrate 111, but also reduces the energy absorbed by the heating film 112 during vaporization. In addition, the thermal conductivity of the materials such as silver, copper, gold, and aluminum is much higher than that of the nickel-chromium alloy, the nickel-chromium-iron alloy, and the iron-chromium-aluminum alloy, which is conducive to rapid heat conduction and enhancement of vaporization efficiency. The heating film 112 made of the materials such as silver, copper, gold, and aluminum may operate stably for a long time in a PG/VG mixture (a propylene glycol/glycerol mixture), but the aerosol-forming medium further contains various flavors, fragrances, and additives. These flavors, fragrances, and additives contain elements such as sulfur, phosphorus, and chlorine, which may cause corrosion to the heating film 112. It is found through experiments that when silver is used as the material of the heating film 112, the resistance of the heating film 112 continues to increase during a wet combustion heat cycle, and the heating film 112 fails after about 30 times of puff. Due to the stronger corrosion resistance of copper to chloride ions, when copper is used as the material of the heating film 112, the resistance of the heating film 112 will still increase during the wet combustion heat cycle, but the life of the heating film 112 can be extended to about 80 times. Aluminum is more stable in the environment of the aerosol-forming medium, and a dense oxide film structure can be formed on a surface of aluminum, which can withstand more than 600 times during thermal cycling. However, gold, as the most chemically stable metal, is more stable and reliable during thermal cycling, and the resistance remains unchanged after more than 1500 thermal cycles.

Therefore, when the material of the heating film 112 is silver or copper, the heating film 112 is prone to corrosion and failure after energized and heated. Due to the strong chemical inertness of gold, a dense oxide film is to be formed on the surface of aluminum. The heating film 112 formed by gold or aluminum is very stable in the aerosol-forming medium, and the heating film 112 is not easy to corrode when energized and heated. Therefore, when the heating element 11 does not include the protective film 115, the material of the heating film 112 is aluminum and its alloys as well as gold and its alloys. When the heating element 11 includes the protective film 115, the protective film 115 can prevent the heating element 11 from being corroded by the aerosol-forming medium, which has no requirement for the material of the heating element 11. The material of the heating film 112 is silver and its alloys, copper and its alloys, aluminum and its alloys, and gold and its alloys.

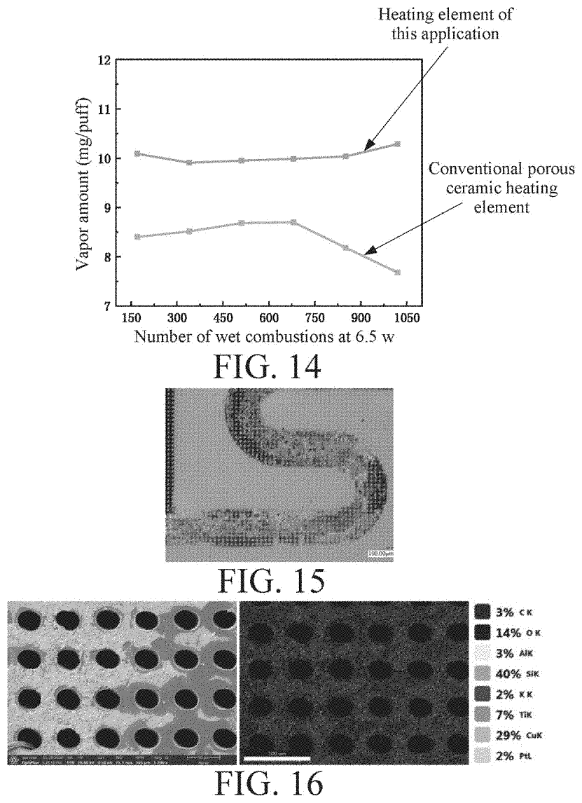

Aluminum is selected as the material of the heating film 112, and is deposited on the first surface 1111 of the dense substrate 111 by magnetron sputtering, and the deposition thickness is 3 micrometers. The obtained SEM image is shown in FIG. 13 (FIG. 13 is an SEM image of an implementation of the heating film according to this disclosure). It may be learned from FIG. 13 that the deposition thickness of the heating film 112 is 3 micrometers, and the heating film 112 is also deposited on the inner surface of the micro-pore 113, which has no obvious impact on the pore size of the micro-pore 113.

Wet combustion was conducted on the heating element 11 provided in this disclosure and the conventional porous ceramic heating element at 6.5 watts to obtain the respective amount of vaporized aerosol for comparison, and the results shown in FIG. 14 are obtained (FIG. 14 is a comparison diagram of an amount of vaporized aerosol of the heating element of this disclosure and an amount of vaporized aerosol of the conventional porous ceramic heating element). A conventional porous ceramic heating element has a porosity in a range of 57%-61%, a thickness of 1.6 mm, and a pore size in a range of 15-50 μm. It can be learned from FIG. 14 that the aerosol amount of the heating element 11 of this disclosure is still stable after 650 times of wet combustion, and the aerosol amount of the conventional porous ceramic heating element begins to decrease significantly after 650 times of wet combustion. With the same number of wet combustions, the amount of aerosol vaporized by the heating element 11 provided in this disclosure is larger than the amount of aerosol vaporized by the conventional porous ceramic heating element. That is to say, the heating element 11 provided in this disclosure can achieve efficient vaporization.

Experiment II: The function of the protective film 115 provided in this disclosure is verified.

A cartridge was loaded into the heating element 11 and wet combustion was performed to evaluate the life of the heating element 11. Experiment conditions: Supply power with 6.5 watts of constant power, and pump for 3 seconds and stop for 27 seconds. The aerosol-forming medium has a mint flavor and nicotine content of 50 mg/100 ml, and the thickness of the heating film 112 is in a range of 1-2 micrometers. The heating element 11 with the protective film 115 is compared with the heating element without the protective film 115, and different materials are selected for the protective film 115 for comparison to simulate the normal use environment of the electronic vaporization device for experiments. The comparison results are shown in Table 2, and relationships between the material of the heating film 112 and the material of the protective film 115 and the life of the heating element 11 are obtained.

TABLE 2
Relationship between the material of the heating film and the material
of the protective film and the life of the heating element

| | Protective film | | | |
|---|---|---|---|---|
| | | | | 316L |
| | | Silicon | Titanium | stainless |
| Heating film | N/A | oxide | nitride | steel |
| Silver | About 30 | About 30 | About 80 | >1500 |
| Copper | About 80 | About 80 | About 130 | >1500 |
| Aluminum | >600 | >600 | >600 | >1500 |

In Table 2, the thickness of the protective film 115 made of silicon dioxide is 30 nm, the thickness of the protective film 115 made of titanium nitride is 100 nm, and the thickness of the protective film 115 made of 316L stainless steel is 800 nm. It can be learned from Table 2 that when silver and copper are used as the materials of the heating film 112, the heating film is easily corroded by the flavors, fragrances, and additives containing elements such as sulfur, phosphorus and chlorine in the aerosol-forming medium, and therefore it is difficult to meet the requirements for life. When aluminum is used as the material of the heating film 112, the heating film can withstand more than 600 thermal cycles, which can satisfy the operating conditions of most electronic vaporization devices (the power of the electronic vaporization device is in a range of 6 watts to 8.5 watts), but it is difficult to meet the requirement of more than 1500 times when the power of the electronic vaporization device is greater than 10 watts.

When silicon dioxide is used as the material of the protective film 115, due to the large difference between a thermal expansion coefficient of silicon dioxide and a thermal expansion coefficient of metal, the internal stress between the film layers during thermal cycling will cause the protective film 115 to fail rapidly, and the protective film cannot play a protective role. It may be understood that when zirconia and alumina are used as the material of the protective film 115, the thermal expansion coefficients of zirconia, alumina, and metal are too large, and therefore the protective film is easy to fail and cannot play the protective role.

Titanium nitride is used as a commonly used protective coating. In this disclosure, copper is used as the material of the heating film 112 to verify whether titanium nitride is suitable to be used as the material of the protective film 115. During the wet combustion, the resistance of the heating film 112 increases continuously, and the heating film 112 fails after 130 thermal cycles (as shown in FIG. 15, FIG. 15 is a failure diagram of the heating film in the heating element of this disclosure). Through observation by using an optical microscope, it is found that the heating film 112 is severely corroded and falls from the dense substrate 111. It can be found from FIG. 16 (FIG. 16 is an SEM image and an EDS image of the failure diagram of the heating film provided in FIG. 15) that the titanium nitride layer on the surface of the heating film 112 has been basically completely corroded, the copper layer of the heating film 112 is exposed and is also severely corroded, and the dense substrate 111 is exposed in some regions. That is, in this disclosure, the protective film 115 made of titanium nitride is also easily corroded by the aerosol-forming medium.

When stainless steel is used as the material of the protective film 115, regardless of whether the material of the heating film 112 is silver, copper, or aluminum, the heating film can withstand more than 1500 thermal cycles, which can greatly increase the life of the heating element 11. Moreover, it is found through experiments that metal with higher nickel content can protect the heating film 112.

Therefore, this disclosure adopts corrosion-resistant stainless steel (304, 316L, 317L, 904L, or the like), the nickel-chromium-iron alloys (inconel625, inconel718, or the like), the nickel-based corrosion-resistant alloys (the nickel-molybdenum alloy B-2, the nickel-chromium-molybdenum alloy C-276), or the like as the material of the protective film 115 to increase the life of the heating element 11. Regardless of whether the material of the heating film 112 is silver, copper, or aluminum, after the protective film 115 is used, the life of the heating element 11 can be greatly increased.

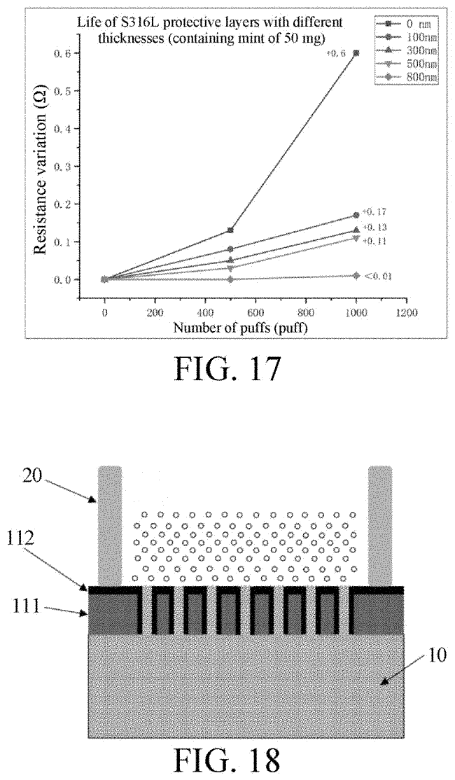

The life of the heating film 112 increases with an increase in the thickness of the protective film 115, as shown in FIG. 17 (FIG. 17 is a graph showing a relationship between lifetime of the heating film and a thickness of the protective film in the heating element according to this disclosure). It can be learned from FIG. 17 that when the aerosol-forming medium adopts mint of 50 mg and the material of the protective film 115 is S316L stainless steel, with the increase in the thickness of the protective film 115, the resistance variation of the heating film 112 is smaller, and the life of the heating film 112 is longer.

Experiment III: The impact of the thickness of the dense substrate 111 and the pore size of the micro-pore 113 on the liquid supply efficiency is obtained.

The liquid supply efficiency of the heating element 11 is evaluated by performing wet combustion on the heating element 11. The principle of the wet combustion is shown in FIG. 18 (FIG. 18 is a schematic diagram of wet combustion performed on a heating element according to this disclosure). DC power supply is used to supply power, and the electrode 1122 of the heating film 112 is connected by using ejector pins 20 of the power supply component 2 (the ejector pins 20 are electrically connected to the battery) to control the energization power and energization time, and a temperature of the heating film 112 is measured by using an infrared thermal imager or a thermocouple.

When the heating film 112 is energized, the temperature rises instantaneously, and the aerosol-forming medium in the micro-pore 113 is vaporized. With consumption of the aerosol-forming medium in the micro-pore 113, the capillary action of the micro-pore 113 causes the aerosol-forming medium in the liquid storage cavity 10 to continuously supplement the heating film 112.

The flow of the aerosol-forming medium in the micro-pore 113 with the capillary action may be calculated according to the Washburn's equation. S is a pore area of the micro-pore 113, ρ is the density of the aerosol-forming medium, z is a distance passed by the aerosol-forming medium, γ is the surface tension, μ is the viscosity of the aerosol-forming medium, r is the radius of the micro-pore 113, and θ is a contact angle between the aerosol-forming medium and the material of the dense substrate 111. The vaporization amount of the aerosol-forming medium is as follows.

$$M ( t ) = S \cdot ρ \cdot z ( t ) = π {r}^{2} \cdot ρ \cdot {( \frac{γ r cos θ}{2 μ} )}^{1 / 2} {t}^{1 / 2}$$

It can be seen from the formula that after the materials of the aerosol-forming medium and the dense substrate 111 are determined, ρ, γ, μ, and θ remain unchanged. A larger pore size of the micro-pore 113 leads to more sufficient liquid supply, but the risk of the aviation negative pressure during the transportation of the product and the risk of liquid leakage caused by temperature shock during use will also be greater. Therefore, the thickness, the pore size, and the aspect ratio of the dense substrate 111 are very important, which not only can ensure sufficient liquid supply during the vaporization, but also can prevent the leakage of the aerosol-forming medium.

The heating element 11 is installed and tested to evaluate the relationship between the ratio of the thickness of the dense substrate 111 to the pore size of the micro-pore 113 and the vaporization amount. The result is shown in FIG. 19 (FIG. 19 is a graph showing a relationship between a ratio of a thickness of the dense substrate of the heating element according to this disclosure to a pore size of a micro-pore and a vaporization amount). It can be seen from FIG. 19 that when the ratio of the thickness of the dense substrate 111 to the pore size of the micro-pore 113 is too large, the aerosol-forming medium supplied by capillary action cannot meet the demand for vaporization, and the vaporization amount decreases. When the ratio of the thickness of the dense substrate 111 to the pore size of the micro-pore 113 is too small, the aerosol-forming medium easily flows out from the micro-pore 113 to the surface of the heating film 112, resulting in a decrease in the vaporization efficiency and a decrease in the vaporization amount.

Experiment IV: The performance of the heating element 11 provided in this disclosure is compared with the performance of the conventional porous ceramic heating element.

If the supply of the aerosol-forming medium is sufficient, in a state of thermal equilibrium, the temperature of the heating film 112 will be maintained around the boiling point of the aerosol-forming medium.

If the supply of the aerosol-forming medium is insufficient, dry burning occurs, and the temperature of the heating film 112 is higher than the boiling point of the aerosol-forming medium. Therefore, the liquid supply efficiency of the heating element 11 can be evaluated by performing wet combustion on the heating element 11.

The thickness of the dense substrate 111 of the heating element 11 provided in this disclosure is 0.2 mm, and the pore size of the micro-pore 113 is 30 micrometers. The above heating element 11 is compared with the conventional porous ceramic heating element (the porosity is in a range of 57% to 61%, the thickness is 1.6 mm, and the pore size is in a range of 15-50 μm).

For the conventional porous ceramic heating element, under the power of 6.5 w, the temperature of the heating film instantly rises to around 270° C. after energized, and the temperature is almost stable during the heating duration of 3 seconds, so as to reach a state of thermal equilibrium. However, with the increase of heating power, the temperature of the heating film in the thermal equilibrium state continues to rise, indicating that the liquid supply of the porous ceramic structure responsible for the liquid guide function is insufficient, as shown in FIG. 20 (FIG. 20 is a graph showing a relationship between a vaporization temperature and a heating power of the conventional porous ceramic heating element).

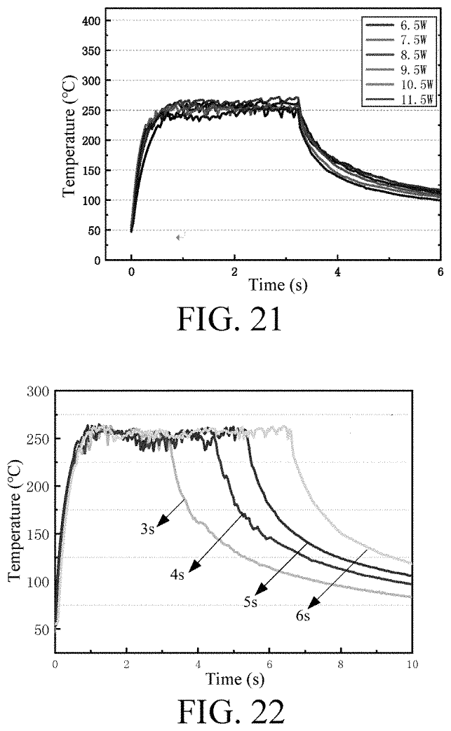

Relatively speaking, when the heating element 11 having the thickness of the dense substrate 111 being 0.2 mm and the pore size of the micro-pore 113 being 30 μm is used, the temperature of the heating film 112 in the thermal equilibrium state is around 250° C. within the power range of 6.5 w to 11.5 w, which is shown in FIG. 21 (FIG. 21 is a graph showing a relationship between a vaporization temperature and a heating power of the heating element of this disclosure). This indicates that the dense substrate 111 of the structure has sufficient liquid supply, and no liquid leakage is found in the experiment.

Under the heating power of 6.5 w, the relationship between the vaporization temperature and the puffing time of the heating element 11 provided in this disclosure is studied, which is shown in FIG. 22 (FIG. 22 is a graph showing a relationship between a vaporization temperature and a puffing time of the heating element of this disclosure). It can be seen from FIG. 22 that as the heating time increases, the vaporization temperature of the heating element 11 provided in this disclosure is also stable in the thermal equilibrium state. This indicates that with the continuous consumption of the aerosol-forming medium in the micro-pore 113, when vaporization occurs after the boiling, the aerosol-forming medium in the liquid storage cavity 10 can be continuously supplied, which can meet the demand for vaporization and ensure the vaporization amount.

The heating element in this disclosure includes a dense substrate and a heating film. The dense substrate includes a first surface and a second surface opposite to the first surface. A plurality of micro-pores are arranged in the dense substrate, the micro-pores are through holes, and each of the micro-pores is configured to guide an aerosol-forming medium to the first surface. The heating film is formed on the first surface. A ratio of a thickness of the dense substrate to pore size of the micro-pore is in a range of 20:1-3:1. Through the above arrangement, the magnitude of the porosity of the heating element can be precisely controlled, thereby improving the consistency of products, and the sufficient liquid supply and the prevention of liquid leakage are both realized during the operation of the heating element.

The foregoing descriptions are merely implementations of this disclosure, and the protection scope of this disclosure is not limited thereto. All equivalent structure or process changes made according to the content of this specification and accompanying drawings in this disclosure or by directly or indirectly applying this disclosure in other related technical fields shall fall within the protection scope of this disclosure.

What is claimed is:

1. A heating element, for heating and vaporizing a liquid aerosol-forming medium, the heating element comprising:
a dense substrate, comprising a first surface and a second surface opposite to the first surface, wherein a plurality of micro-pores are arranged in the dense substrate, the micro-pores are through holes, and each of the micro-pores is configured to guide the aerosol-forming medium to the first surface; and
a heating film, formed on the first surface, wherein
a ratio of a thickness of the dense substrate to a pore size of the micro-pore is in a range of 20:1-3:1.

2. The heating element of claim 1, wherein the plurality of micro-pores are arranged in an array.

3. The heating element of claim 2, wherein shapes and the pore sizes of the plurality of micro-pores are the same, and the plurality of micro-pores are arranged in a rectangular array.

4. The heating element of claim 2, comprising the array has a first region and a second region, and the micro-pores in the second region have a pore size that is different from a pore size of the micro-pores in the first region.

5. The heating element of claim 1, wherein the first surface is a plane, each micro-pore is a straight-through hole perpendicularly extending through the first surface and the second surface, and a cross-section of the micro-pore is circular.

6. The heating element of claim 5, wherein the first surface and the second surface are both planes and are arranged in parallel.

7. The heating element of claim 1, wherein the dense substrate is made of glass or dense ceramic.

8. The heating element of claim 7, wherein the dense substrate is made of one of borosilicate glass, quartz glass, or photosensitive lithium aluminosilicate glass.

9. The heating element of claim 8, wherein the ratio of the thickness of the dense substrate to the pore size of the micro-pore is in a range of 15:1-5:1.

10. The heating element of claim 8, wherein a ratio of a distance between centers of two adjacent micro-pores to the pore size of the micro-pore is in a range of 3:1-1.5:1.

11. The heating element of claim 8, wherein a ratio of a distance between centers of two adjacent micro-pores to the pore size of the micro-pore is in a range of 3:1-2.5:1.

12. The heating element of claim 8, wherein the thickness of the dense substrate is in a range of 0.1 millimeters to 1 millimeter.

13. The heating element of claim 8, wherein the thickness of the dense substrate is in a range of 0.2 millimeters to 0.5 millimeters.

14. The heating element of claim 8, wherein the pore size of the micro-pore is in a range of 1 micrometer to 100 micrometers.

15. The heating element of claim 8, wherein the pore size of the micro-pore is in a range of 20 micrometers to 50 micrometers.

16. The heating element of claim 1, wherein a longitudinal section of each through hole has a rectangle shape or a dumbbell shape.

17. The heating element of claim 1, wherein the micro-pore extends through the heating film.

18. The heating element of claim 17, wherein:
the heating film is made of silver, copper, aluminum, gold, or an alloy thereof,
a thickness of the heating film is in a range of 200 nanometers to 5 micrometers,
a resistance of the heating film is in a range of 0.5 Ohms to 2 Ohms, and
a resistivity of the heating film is not greater than 0.06×10⁻⁶ Ωm.

19. The heating element of claim 1, wherein the heating film is made of a nickel-chromium alloy, a nickel-chromium-iron alloy, an iron-chromium-aluminum alloy, nickel, platinum, or titanium, and a thickness of the heating film is in a range of 5 micrometers to 100 micrometers.

20. The heating element of claim 1, wherein the heating film has a shape of a sheet, a grid, and a strip.

21. The heating element of claim 1, further comprising a protective film arranged on a surface of the heating film away from the dense substrate, the protective film being made a stainless steel, a nickel-chromium-iron alloy, or a nickel-based corrosion-resistant alloy.

22. A vaporization component, comprising:
a liquid storage cavity, configured to store a liquid aerosol-forming medium; and
a heating element, comprising:
a dense substrate, comprising a first surface and a second surface opposite to the first surface, wherein a plurality of micro-pores are arranged in the dense substrate and in communication with the liquid storage cavity, the micro-pores are through holes, and each of the micro-pores is configured to guide the aerosol-forming medium to the first surface; and
a heating film, formed on the first surface, wherein:
a ratio of a thickness of the dense substrate to a pore size of the micro-pore is in a range of 20:1-3:1.

23. The vaporization component of claim 22, further comprising a loose substrate arranged on the second surface of the dense substrate of the heating element.

24. The vaporization component of claim 23, wherein the loose substrate is made of a porous ceramic, a sponge, a foam, or a fiber layer.

25. An electronic vaporization device, comprising:
a vaporization component, having:
a liquid storage cavity, configured to store a liquid aerosol-forming medium; and
a heating element, comprising:
a dense substrate, comprising a first surface and a second surface opposite to the first surface, wherein a plurality of micro-pores are arranged in the dense substrate and in communication with the liquid storage cavity, the micro-pores are through holes, and each of the micro-pores is configured to guide the aerosol-forming medium to the first surface; and
a heating film, formed on the first surface, wherein:
a ratio of a thickness of the dense substrate to a pore size of the micro-pore is in a range of 20:1-3:1; and
a power supply component, electrically connected to the heating element.

26. The electronic vaporization device of claim 25, wherein the power supply component comprises a battery, a voltage of the battery is in a range of 2.5 volts to 4.4 volts, and a power of the electronic vaporization device is in a range of 6 watts to 8.5 watts.
